(19) United States
(12) Patent Application Publication
(10) Pub. No.: US 2013/0178188 A1
(43) Pub. Date: Jul. 11, 2013

(54) MODELING BILLING IMPACTS IN DATA SENSITIVE ENVIRONMENTS

(71) Applicants: David Judkins, Round Rock, TX (US); Charles Chapman Moore, Plano, TX (US)

(72) Inventors: David Judkins, Round Rock, TX (US); Charles Chapman Moore, Plano, TX (US)

(73) Assignee: Enfora, Inc., Richardson, TX (US)

(21) Appl. No.: 13/605,826

(22) Filed: Sep. 6, 2012

Related U.S. Application Data
(60) Provisional application No. 61/531,489, filed on Sep. 6, 2011.

(51) Int. Cl. H04W 4/26

(52) U.S. Cl. CPC H04W 4/26
USPC 455/406

(57) ABSTRACT

Systems and methods generate a data usage plan for a mobile device. A method includes identifying a plurality of data usage requirements for the mobile device. The method includes identifying one or more carrier models for data service costs. The method includes generating cost estimates for a plurality of data usage transactions based on the data usage requirements and one or more carrier models. The method includes generating the data usage plan for the mobile device based on the cost estimates. The data usage plan includes usage parameters for carrier selection by the mobile device.

### CROSS-REFERENCE TO RELATED APPLICATIONS AND CLAIM OF PRIORITY

The present application is related to U.S. Provisional Patent Application No. 61/531,489 filed Sep. 6, 2011 entitled “MODELING BILLING IMPACTS IN DATA SENSITIVE ENVIRONMENTS.” U.S. Provisional Patent Application No. 61/531,489 is hereby incorporated by reference into the present application as if fully set forth herein. The present application hereby claims priority under 35 U.S.C. §119(e) to U.S. Provisional Patent Application No. 61/531,489.

### TECHNICAL FIELD

Generally, the present disclosure relates to data transfers and, more specifically, to the optimization of data usage within a wireless network using a plurality of models given a plurality of billing impacts.

### BACKGROUND

Wireless data networks provide delivery of data between a carrier network and a client. This delivery typically represents a significant percentage of operating costs and varies based upon a number of different variables.

In order to optimize business operations, a client needs to understand options available for data transfer and be able to modify data transport mechanisms to minimize ongoing operational costs. Therefore, systems and methods are needed to minimize data transfer costs in wireless data networks.

### SUMMARY

Various embodiments of the present disclosure provide systems and methods for generating a data usage plan for a mobile device.

In one embodiment, there is provided a method for generating a data usage plan for a mobile device. The method includes identifying a plurality of data usage requirements for the mobile device; identifying one or more carrier models for data service costs; generating cost estimates for a plurality of data usage transactions based on the data usage requirements and one or more carrier models; and generating the data usage plan for the mobile device based on the cost estimates, wherein the data usage plan includes usage parameters for carrier selection by the mobile device.

In another embodiment, there is provided a system for generating a data usage plan for a mobile device. The system includes a storage device and a processor operably coupled to the storage device. The processor is configured to: identify a plurality of data usage requirements for the mobile device, identify one or more carrier models for data service costs, generate cost estimates for a plurality of data usage transactions based on the data usage requirements and one or more carrier models, and generate the data usage plan for the mobile device based on the cost estimates, wherein the data usage plan includes usage parameters for carrier selection by the mobile device.

In yet another embodiment, there is provided a non-transitory computer-readable medium embodying a computer program. The computer program includes program code for: identifying a plurality of data usage requirements for the mobile device; identifying one or more carrier models for data service costs; generating cost estimates for a plurality of data usage transactions based on the data usage requirements and one or more carrier models; and generating the data usage plan for the mobile device based on the cost estimates, wherein the data usage plan includes usage parameters for carrier selection by the mobile device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, and those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 illustrates a block diagram of billing estimation environment including a system utilizing a billing estimation module according to various embodiments of the present disclosure;

FIG. 2 illustrates a block diagram of the billing estimation module shown in FIG. 1 according to various embodiments of the present disclosure;

FIG. 3 illustrates a block diagram of an example carrier model according to various embodiments of the present disclosure;

FIG. 4 illustrates a block diagram of an example data model according to various embodiments of the present disclosure;

FIG. 5 illustrates a block diagram of an example of a data usage plan according to various embodiments of the present disclosure;

FIG. 6 illustrates a process for generating a data usage plan for a mobile device according to various embodiments of the present disclosure; and

FIG. 7 illustrates a process for comparing carrier options according to various embodiments of the present disclosure.

### DETAILED DESCRIPTION

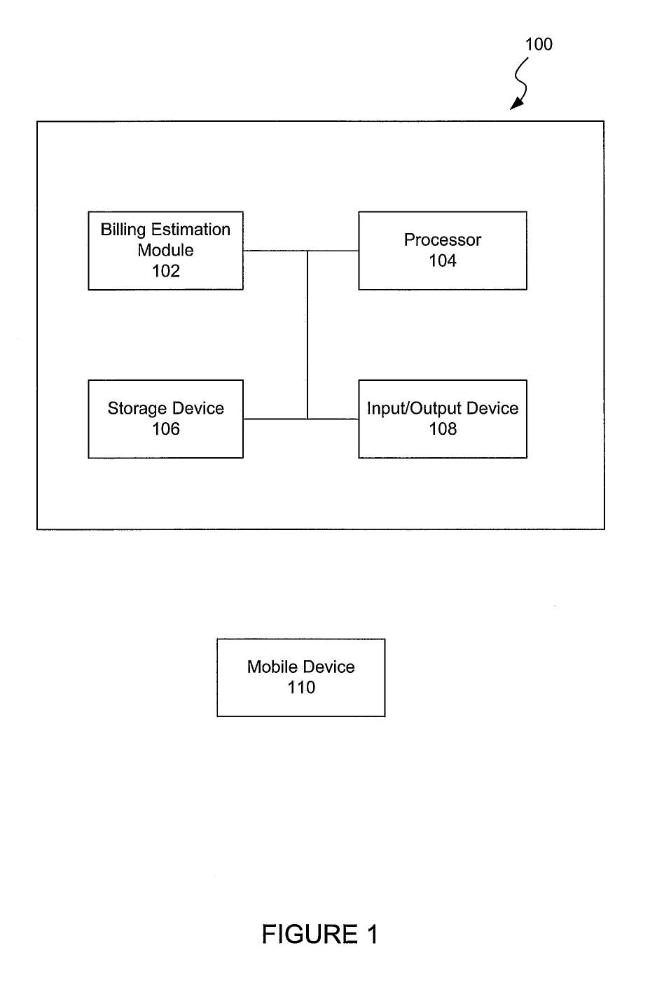

FIGS. 1 through 7, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

In order to provide clarity to some of the disclosed embodiments, the phrase “data usage plan”, “data model”, and “carrier model” will be briefly discussed. These discussions are not intended to be limiting, but are rather for the purpose of providing clarity to one or more of the embodiments disclosed here.

The term “model” is intended to refer to any representation of data and relationships of the data. Models can define data elements and relationships among data elements for a domain of interest. Data models may be stored in a physical memory using one or more databases and formatted using a plurality of different schemas, including a conceptual schema, logical schema, and physical schema. The model, as used herein, may further be embodied in a data flow diagram, an information model, an object model, and object-role mode, or a unified model language model (UML).

The phrase “data usage plan” can refer to a model which describes or determines the wireless service carrier to be used, the time to use the wireless carrier, and the functionality provided by the wireless carrier by a data model.

The phrase “data model” can refer to a model that includes information about how much data needs to be transferred when, and includes requirements for the amount of data, encryption requirements, guaranteed delivery requirements, and cost of maintaining accessibility to and from a server.

The phrase “carrier model” is intended to refer to information included in a model that refers to how much it costs to access a particular wireless or wired carrier network. These costs include cost to maintain connectivity, cost to transfer data (including cost variability based upon time) and cost of transmitting different quantities (at different times and at different locations).

In one embodiment of the present disclosure, a data model and carrier model are used to create and implement a data usage plan. This data usage plan can further be loaded or programmed into a wireless device.

In another embodiment, a data usage plan and a data model may have been previous loaded into a machine. The machine evaluates new carrier models for possible changes to operations (e.g., introduction of additional Wi-Fi hotspots, switching to a new carrier plan, etc.). Based upon the evaluation of the new carrier models, changes may be made to the operations of one or more devices.

In yet another embodiment, a number of carrier models and an operational environment are known and loaded/input into a machine. The machine evaluates the cost impacts of different data models with associated data usage plans. For example, the machine may evaluate the costs of guaranteed delivery, encryption, and authentication, introducing new geographic coverage, and adding additional data. It is contemplated that these costs may be financial and evaluated in terms of the relative impact on other systems of the wireless device (e.g., more data to be transmitted by a device may have a higher cost in terms of requirements on a device).

In some embodiments, a system 100 provides functionality and the ability to analyze billing impacts of different device configurations in mobile operating environments. By simulating the amount of traffic that is being communicated (transmitted and received) over at least one available network, creating a billing model for the carriers offering service, and modifying usage parameters, the cost of various transfer configurations can be compared and selected as part of a device management process. The usage parameters may include, for example, without limitation, reporting intervals, the quantity of information being requested, scheduling of reports to lower cost time windows, selection of lowest cost transport and management of reconfiguration and re-provisioning the device.

The various embodiments of the present disclosure recognize that current billing may be negotiated based upon carrier offerings and/or analyzed after deployment and requests for bandwidth reduction can be made after a cost analysis of the total solution expenses has been made. To a large degree, this may be important because one vendor may be providing the devices while another vendor may be providing the server application that communicates with the devices. As a result, there is no end-to-end analysis of the data requirements for the total solution.

The various embodiments of the present disclosure recognize that one of the problems with this current approach is the lack of an end-to-end analysis. This lack of end-to-end analysis means that the total cost of operation is not really known at the time when a system is developed. Moreover, such a system cannot be modified as new options become available. An end-to-end analysis, as described herein, allows the total cost of operation to be determined at an earlier stage and the intelligent selection of various variables from operational variables (e.g., when and how to send data) to hardware variables (e.g., what providers to use and what technology choices to make during transmission).

FIG. 1 illustrates a block diagram of billing estimation environment 101 including a system 100 utilizing a billing estimation module 102 according to various embodiments of the present disclosure. As illustrated, the system 100 includes a processor 104 configured to access (or provide information to) a billing estimation module 102, storage device 106, and input/output device(s) (I/O) 108. In one embodiment, the processor 104 may be further configured to operate in conjunction with the billing estimation module 102 to obtain or develop a solution to preferred variables. Below are described four example calculations performed by the processor in conjunction with the billing estimation module 102. It will be appreciated that the billing estimation module may include processing functionality or processing device to enable the module itself to perform calculations.

The system 100 can calculate or generate data transport cost information for a mobile device 110. In these illustrative examples, the mobile device 110 is a device that collects and/or reports data remotely and then transmits the data to a repository, such as, for example, a database in a server or the storage device 106 in the system 100. The mobile device 110 transmits data using wireless communication, such as, for example, cellular data networks (e.g., a mobile communications (GSM) cellular network, a universal mobile telecommunications system (UMTS) cellular network, or a single-carrier radio transmission technology (1xRTT) cellular network), Wi-Fi networks, piconets, etc.

The data transport cost information may include a number of metrics, such as available carriers, cost for network access, cost of data transfer (based upon time, location and quantity), etc. Other data transport costs may be ascertained or determined. The cost impacts resulting from different operational scenarios can be determined, generated or compared. For example, this may include cost impacts from different reporting intervals and reporting times, introducing security, and transferring additional information available at the mobile device 110, such as temperature, device performance statistics, acceleration information, and device orientation, etc.

The system 100 may compare and/or calculate different carrier offerings. For example, the processor 104 may be further configured to use the billing estimation module 102 in order to compare different rate plans, different mobile network providers, and actual usage and costs versus estimated usage and costs.

The system 100 may calculate or predict costs for data traffic from modifying the configuration of the mobile device 110 and from remotely upgrading firmware and/or software for the mobile device 110. This includes assessing or determining data costs, simulation of various schedule alternatives, and exploring the possible use of alternate transports (e.g., using Wi-Fi, piconets, or text message instead of cellular data).

These calculations or processing may be performed at several different times (as desired) during the operational life of the mobile device 110. Possible time frames include: prior to deployment (to determine projected cost prior to deployment), after deployment (in order to explore new carrier pricing options and to manage device configuration), and during system expansion (allowing operators to track and project usage growth and cost of mobile devices).

The processor 104 is further configured to output (and receive) information through I/O 108 to (from) a network, a display or any other device (none shown in FIG. 1) as known to one skilled in the art. And, as known by those of ordinary skill in the art, storage device 106 functions to store parameters, data, firmware, software, etc. for use in the system 100.

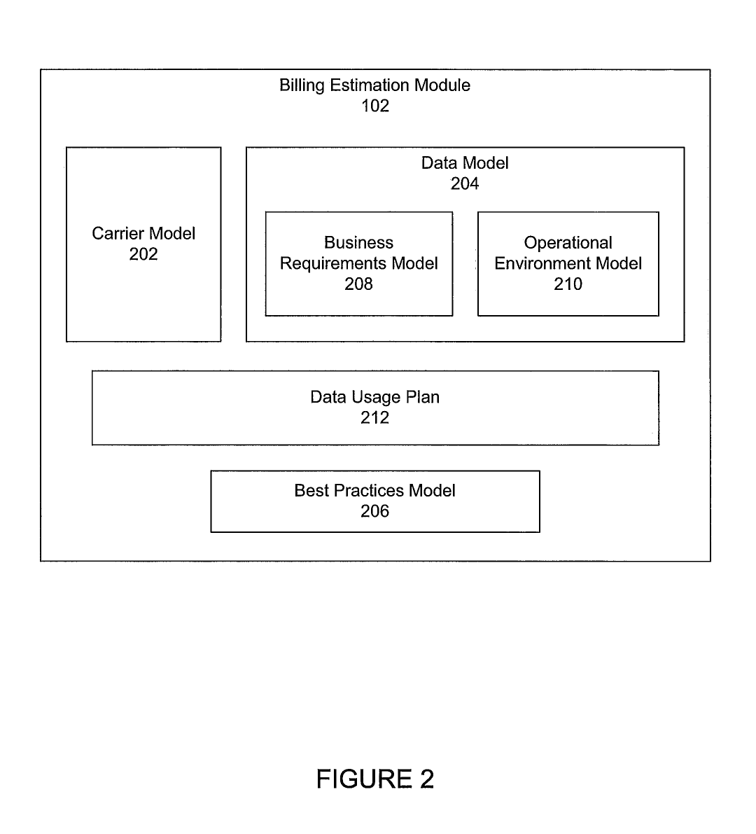

FIG. 2 illustrates in more detail one embodiment of the billing estimation module 102. As shown, the billing estimation module 102 further includes a carrier model 202, a data model 204, a best practices model 206 and a data usage plan 212. The data module 204 includes a business requirements model 208 and an operational model 210.

The carrier model 202 includes a variety of information relating to wireless data carriers. In general, information in the carrier model 202 may be used to determine cost efficiencies of using a particular wireless data carrier at a particular time for a particular purpose. In some embodiments, information in the carrier model 202 is carrier specific and there exists various parameters associated with each of various different wireless data carriers.

Examples of the information that may be included in the carrier model 202 include packet size(s), time of usage, how often the mobile device 110 is connected to the network, possible quantity discounts for large customers, and a number of regionally specific limitations. Other types of information may be related to a plurality of carriers with technology that is compatible with the technology to be implemented. For example, a plurality of carriers may use GSM technology and each carrier having GSM capabilities may be identified within the carrier model 202.

In some embodiments, the carrier model 202 can be multidimensional, with a first dimension relating to various cost aspects of using a particular characteristic, and a second dimension related to separate carriers. In particular embodiments, the information in the carrier model 202 may be provided by the company providing the billing model and may be periodically updated to reflect new billing plans. Additionally, particular functionality may be included to correlate locations where a particular carrier has coverage and utilize this information to form usage parameters related to a plurality of carriers.

In various embodiments, the carrier model 202 may also include carrier specific information on overhead inserted on all data packets, minimum packet size analysis, time-of-day charge modeling, and possible quantity breaks for devices and/or traffic. In addition, the carrier model 202 may also include special offers, regionally specific rate variations, and the possibility of using different networks at different times.

The data model 204 includes information relevant to the modeling of data transfer scenarios that the mobile device 110 and server are expected to experience, including how often the mobile device 110 uses the network, how much data is sent and/or received and the characteristics of the data being transferred (overhead, retransmission, security, etc.).

In some embodiments, the data model 204 may also include reporting frequencies and data content, possible concatenation of data in cases where it is advantageous to send fewer, larger packets and models for firmware upgrade scenarios. Additionally, the data model 204 may include models for re-provisioning mobile device 110 and periodic reporting of device operations.

The best practices model 206 may provide additional information relating to the best practice suggestions for a particular model. These practices may include, but are not limited to, parameters related to usage requirements, reporting requirements, and legal requirements. The usage of this model is optional in particular embodiments, and may be invoked when requested by a particular user.

The projected business requirement model 208 includes estimates of business assets and projected usage costs and the timeframe for these projections.

The operational environment model 208 uses information from the carrier model 202 and the data model 204 to determine cost impacts when parameters are varied, including a variation on carrier models and traffic models. In particular embodiments, “what if” scenarios can be explored, allowing the customer to explore a variety of possible deployment options.

The operational environment model 210 may also determine cost impacts if devices are re-provisioned, cost impacts if firmware upgrades are installed, and cost impacts of different carrier agreements.

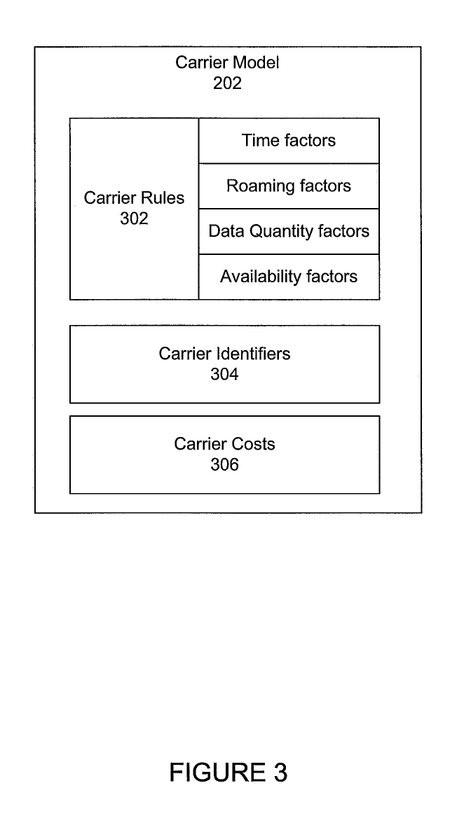

FIG. 3 illustrates a block diagram of an example of elements within various embodiments of the carrier model 202. In this illustrative example, the carrier model 202 includes carrier rules 302, carrier identifiers 304, and carrier costs 306.

The carrier rules 302 define particular rules that are associated with a particular carrier, and may include time factors, roaming factors, data quantity factors and availability factors. As a non-limiting example, the carrier rules 302 may includes different rates or rules based on a specified time period (e.g., during business hours, non-business hours), quantity of data to transmit, roaming operations, and availability of the network.

The carrier costs 306 include the cost per data size (e.g., a kilobyte) transmitted for a particular carrier. The carrier identifiers 304 identify the carrier or carriers associated with one or more carrier rules 302 and carrier costs 306.

Using the combination of the carrier rules 302, the carrier identifiers 304 and the carrier costs 306, the most cost efficient use for a particular carrier or carriers can be determined or calculated. As a non-limiting example, by processing or considering all or some of the carrier model parameters, a first carrier may be identified that, if used, has a rate that is less than a second carrier for the “business day” rate of the second carrier, but more than the rate that is charged by second carrier during the non-business day. Thus, when transmission is required during business hours, the system 302 may utilize the first carrier and when transmission is required during non-business hours, the system 302 may utilize the second carrier. In another example, if time of transmission is somewhat discretionary (i.e., no specific time but once a day), then the system 302 can make a determination to transmit during non-business hours (assuming a rate less than business hours) using the second carrier.

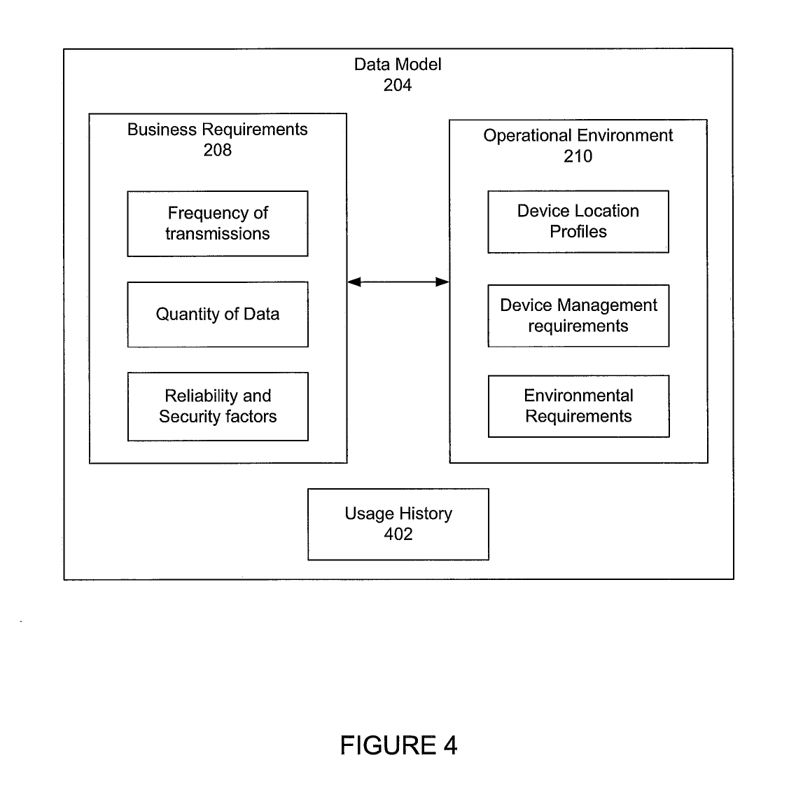

FIG. 4 illustrates a block diagram of an example of elements within various embodiments of the data model 204. In illustrative example, the data model 204 includes the business requirements model 208, the operational environment model 210 and usage history 402. The business requirements model 208 includes parameters or information relating to certain business requirements, while the operational environment model 210 includes parameters or information relating to the operational environment.

For illustrative purposes only, in the example shown in FIG. 4, the business requirements model 208 may describe or specify various parameters, such as those relating to quantity of data, frequency of transmissions, and reliability and security information. For example, the quantity of data (e.g., 10 kb) that will be transferred (per event, per day, etc.) may be considered, and this may also be considered in tandem with a specified security level.

Similarly, the operational environment model 210 may describe or specify various parameters, such as those relating to device location, device management and environmental requirements. For example, the operational environment model 210 may specify that a certain type/amount of data (to be transmitted) is low priority data and, therefore, this data is not required to be transmitted when the mobile device 110 is in a specific location(s).

One of the innovative elements of the data model 204 is the ability to use one or more usage histories 402 to determine the probability of minimal costs. Usage histories 402 may represent historical usage of a number of different elements, including actual data usage. As a non-limiting example, the usage histories 402 may indicate how many times emergency conditions have been invoked.

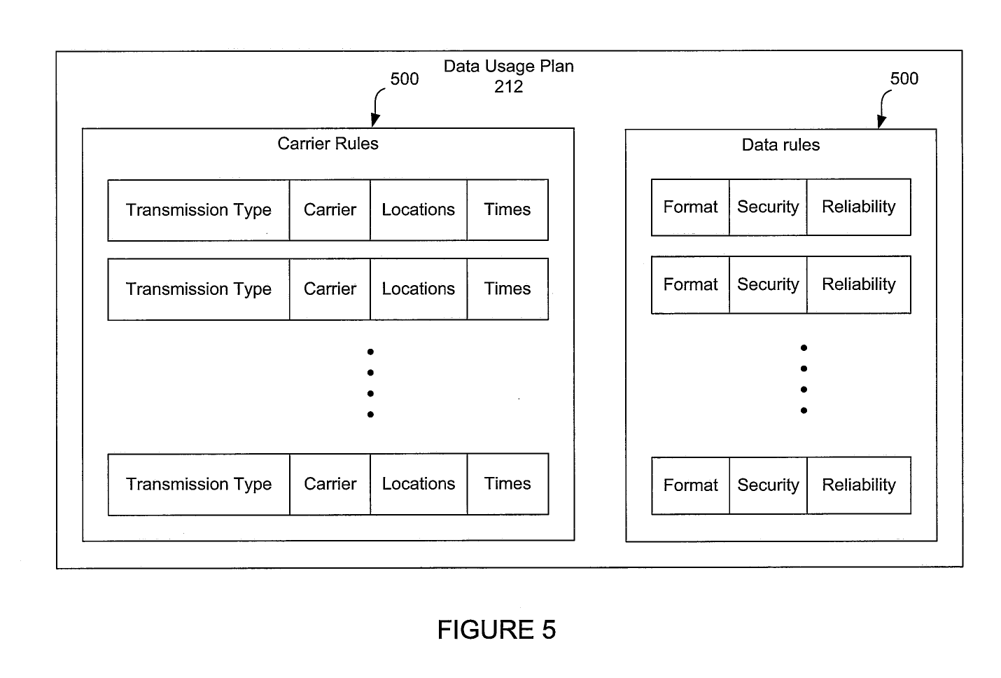

FIG. 5 illustrates a block diagram of an example of the data usage plan 212 according to various embodiments of the present disclosure. As illustrated in the data usage plan 210 in FIG. 5, information from both the carrier model 202 and the data model 204 may be used to determine the usage parameters 500 for the mobile device 110. For instance, during normal operational conditions all data may be transmitted using one carrier, but in specified locations, all data may be transmitted using another carrier. It is explicitly understood that the system 302 may use a plurality of mathematical formulas or algorithms to derive the lowest cost suggestions for different carrier characteristics and/or different data characteristics.

As will be appreciated, the system 100 may assess or utilize one or more pieces of the information and parameters in the data model 204 (and any of the other models) to determine or calculate usage parameters 500 for the mobile device 110. These usage parameters 500 represent or define the process or rules by which the mobile device 110 communicates wirelessly. In most cases, operation of the mobile device 110 will in accordance with the usage parameters 500 will result in a cost effective deployment.

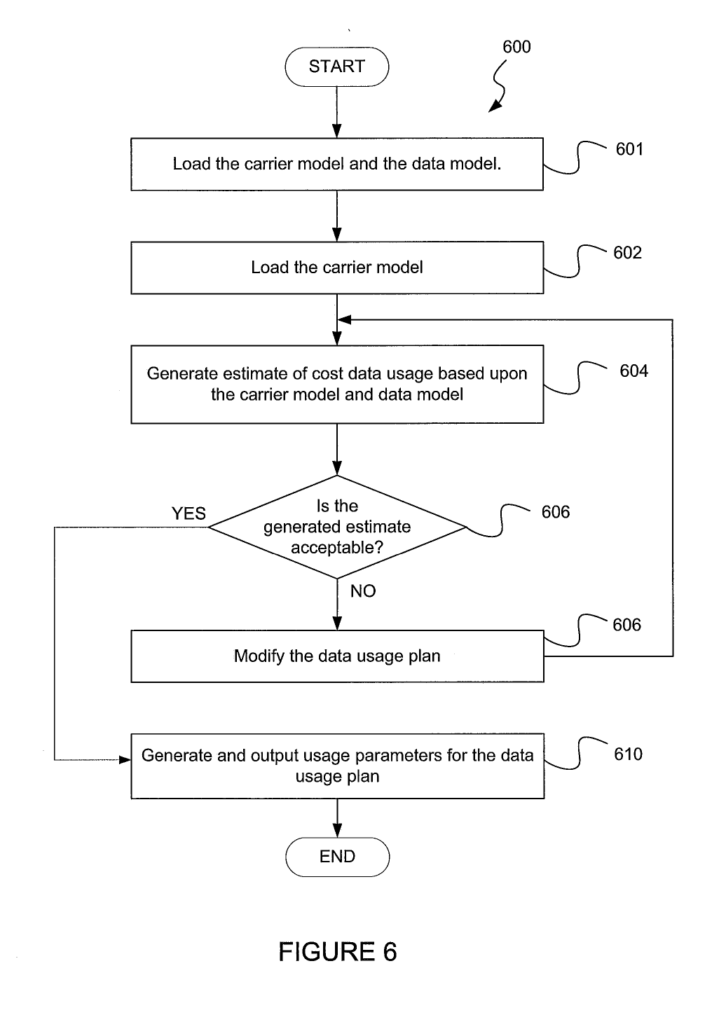

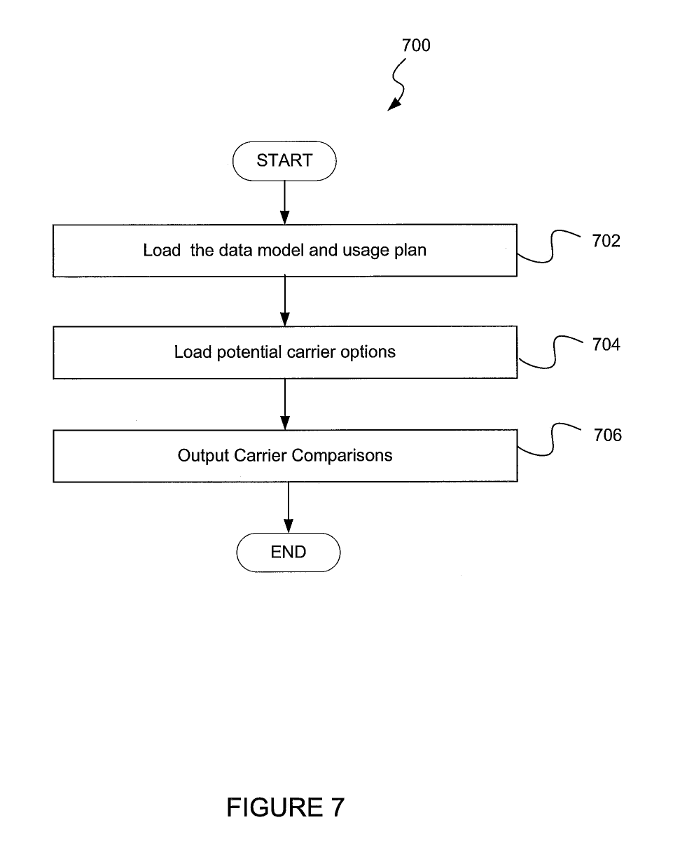

Turning now to FIGS. 6 and 7, there are shown flowcharts illustrating processes using the billing estimation module 102.

FIG. 6 illustrates a process 600 for generating a data usage plan for a mobile device according to various embodiments of the present disclosure. For example, the process 600 may be implemented by the system 100. In various embodiments, the billing estimation module 102 may include program code for implementing the process 600. In blocks 601 and 602, the carrier model 202 and the data model 204 are loaded into the system 100. In block 604, the process 600 generates estimates of the cost of data usage using a particular carrier in a particular operational environment according to the information (e.g., set of parameters) within the carrier model 202 and the data model 204.

In block 606, the process determines whether the generated estimate is acceptable. For example, the process may determine whether the current cost estimates are the lowest among a set of different data usage plans. For example, in block 606, the system 100 may determine the preferred data usage plan based upon a selection criteria, such as cost. If the generated estimate is not acceptable, in block 608, the process 600 modifies the data usage plan. The process 600 then returns to block 604 to generate another estimate. In this manner, the process 600 may iteratively process the data usage plan to determine the preferred data usage plan.

If at block 606, the generate estimate is acceptable, in block 610, the process generates and outputs the usage parameters for the data usage plan. For example, the system 100 may send the data usage plan 212 or the usage parameters 500 to the mobile device 110 for the mobile device 110 to use in future data transmissions.

FIG. 7 illustrates a process 700 for comparing carrier options according to various embodiments of the present disclosure. For example, the process 600 may be implemented by the system 100. In various embodiments, the billing estimation module 102 may include program code for implementing the process 600. In block 702, the data usage plan 212 and the data model 204 are loaded into the system 100. In block 704, a variety of carrier offerings are presented and loaded. In block 706, the carrier rules of the data usage plan are modified to replace different carriers for different transmission types, and a comparison report is generated and output indicating alternative carrier rules with associated costs.

As will be appreciated, the term “cost” may refer to financial costs, but could also refer to other costs, such as opportunity costs and operational costs (e.g., increase in frequency of transmissions, reliability, battery power usage, etc.).

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods. described and illustrated in the various embodiments as discrete or separate may be combined or integrated with other systems, modules, techniques, or methods without departing from the scope of the present disclosure. Other products shown or discussed as directly coupled or communicating with each other may be coupled through some interface or device, such that the products may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

It should be understood that although an exemplary implementation of one embodiment of the present disclosure is illustrated above, the present system may be implemented using any number of techniques, whether currently known or in existence. The present disclosure should in no way be limited to the exemplary implementations, drawings, and techniques illustrated above, including the exemplary design and implementation illustrated and described herein, but may be modified within the scope of the appended claims along with their full scope of equivalents.

What is claimed is:

1. A method for generating a data usage plan for a mobile device, the method comprising:
identifying a plurality of data usage requirements for the mobile device;
identifying one or more carrier models for data service costs;
generating cost estimates for a plurality of data usage transactions based on the data usage requirements and one or more carrier models; and
generating the data usage plan for the mobile device based on the cost estimates, wherein the data usage plan includes usage parameters for carrier selection by the mobile device.

2. The method of claim 1, wherein the data usage plan further includes usage parameters for prioritizing among carriers in the presence of different carriers.

3. The method of claim 1, wherein the carrier selection is one of a global system for mobile communications (GSM) cellular network, a universal mobile telecommunications system (UMTS) cellular network, and a single-carrier radio transmission technology (1xRTT) cellular network.

4. The method of claim 1, wherein the carrier selection is a wireless fidelity (WiFi) network.

5. The method of claim 1, wherein generating the cost estimates for the plurality of data usage transactions comprises simulating the costs for the data usage transactions using a plurality of different reporting intervals and reporting times.

6. The method of claim 1, wherein generating the cost estimates for the plurality of data usage transactions comprises simulating the costs for the data usage transactions using different overhead, security, and retransmission characteristics.

7. The method of claim 1, wherein generating the cost estimates for the plurality of data usage transactions comprises simulating the costs for the data usage transactions using a plurality of different carriers and rate plans.

8. The method of claim 1, wherein identifying the plurality of data usage requirements comprises generating a data model based on device data usage history.

9. The method of claim 1, wherein generating the data usage plan comprises generating the data usage plan prior to deployment of the mobile device.

10. A system for generating a data usage plan for a mobile device, the system comprising:
a storage device; and
a processor operably coupled to the storage device, the processor configured to:
identify a plurality of data usage requirements for the mobile device;
identify one or more carrier models for data service costs;
generate cost estimates for a plurality of data usage transactions based on the data usage requirements and one or more carrier models; and
generate the data usage plan for the mobile device based on the cost estimates, wherein the data usage plan includes usage parameters for carrier selection by the mobile device.

11. The system of claim 10, wherein the data usage plan further includes usage parameters for prioritizing among carriers in the presence of different carriers.

12. The method of claim 10, wherein to generate the cost estimates for the plurality of data usage transactions the processor is configured to simulate the costs for the data usage transactions using a plurality of different reporting intervals and reporting times.

13. The system of claim 10, wherein to generate the cost estimates for the plurality of data usage transactions the processor is configured to simulate the costs for the data usage transactions using different overhead, security, and retransmission characteristics.

14. The system of claim 10, wherein to generating the cost estimates for the plurality of data usage transactions the processor is configured to simulate the costs for the data usage transactions using a plurality of different carriers and rate plans.

15. The system of claim 10, wherein to identify the plurality of data usage requirements the processor is configured to generate a data model based on device data usage history.

16. The system of claim 10, wherein the data usage plan prior is generated prior to deployment of the mobile device.

17. A non-transitory computer-readable medium embodying a computer program, the computer program comprising program code for:
identifying a plurality of data usage requirements for the mobile device;
identifying one or more carrier models for data service costs;
generating cost estimates for a plurality of data usage transactions based on the data usage requirements and one or more carrier models; and
generating the data usage plan for the mobile device based on the cost estimates, wherein the data usage plan includes usage parameters for carrier selection by the mobile device.

18. The computer-readable medium of claim 17, wherein the data usage plan further includes usage parameters for prioritizing among carriers in the presence of different carriers.

19. The computer-readable medium of claim 17, wherein the program code for generating the cost estimates for the plurality of data usage transactions comprises program code for simulating the costs for the data usage transactions using a plurality of different reporting intervals and reporting times.

20. The computer-readable medium of claim 17, wherein the program code for generating the cost estimates for the plurality of data usage transactions comprises program code for simulating the costs for the data usage transactions using different overhead, security, and retransmission characteristics.
